(19) United States
(12) Patent Application Publication
(10) Pub. No.: US 2011/0307788 A1
(43) Pub. Date: Dec. 15, 2011

(54) ROLE-BASED PRESENTATION VIEWS

(75) Inventors: Daniel Cheung, Mountain View, CA (US); Allen Huang, Mountain View, CA (US)

(73) Assignee: Microsoft Corporation, Redmond, WA (US)

(21) Appl. No.: 12/815,404

(22) Filed: Jun. 15, 2010

(51) Int. Cl. G06F 3/01; G06F 15/16

(52) U.S. Cl. 715/731; 715/733; 715/751

(57) ABSTRACT

A presentation state that includes a presentation and other information is synchronized between one or more client computers executing a presentation client application. A client computer executing the presentation client application receives the presentation state, including the presentation, and is assigned a role. The client computer then provides a user interface (“UI”) for viewing and interacting with the presentation that is based upon the assigned role. The role might be a projector role, a presenter role, an attendee role, a moderator role, a notetaker role, or another type of role. The UI might also be customized for the particular type of client computer that it is displayed upon.

### BACKGROUND

It is very common in today's business and academic environments for presentations to be made using a desktop or laptop computer equipped with a presentation application program and an external display, such as a projector or a large monitor. Meeting participants can view the presentation on the external display. Remotely located participants may be able to establish a network connection that enables them to view the presentation remotely. Both local and remotely located meeting participants are typically provided the same view of the presentation, which is the current focus of the current presenter.

It is also common in today's business and academic environments for meeting participants to have one or more computing devices of their own. For instance, it is not uncommon for a meeting participant to have a laptop computer and a smartphone. Meeting participants frequently use these types of computing devices to perform tasks that are unrelated to the presentation, such as reading electronic mail (“e-mail”) messages and browsing the World Wide Web (the “Web”). Use of these devices in this manner may be distracting to the meeting participant, to other meeting participants, and to the presenter.

It is with respect to these and other considerations that the disclosure made herein is presented.

### SUMMARY

Technologies are described herein for providing a view of a presentation that is based upon a role assigned to a meeting participant. Through the utilization of these technologies, a view of a presentation can be provided to each meeting participant on their own computing device that is customized to the particular role and device of the meeting participant. By interacting with a view of a presentation that has been customized for their particular role and device, meeting participants may become more engaged in the presentation and less likely to engage in distractive activities.

According to one aspect presented herein, a number of client computers are configured with a presentation client application. A server computer is also provided that is configured with a presentation server application. The presentation server application is configured to maintain and synchronize a presentation state among the client computers. The presentation state might include a presentation, presentation collateral, notes, questions, an attendee list, chat data, annotations, and/or other information. In other embodiments, a peer-to-peer network might be utilized to synchronize the presentation state between the client computers rather than a server computer. Other mechanisms might also be utilized.

According to another aspect, a client computer executing the presentation client application receives a presentation and is assigned a role. The client computer then provides a user interface (“UI”) for viewing and interacting with the presentation that is based upon the assigned role. The role might be a projector role, a presenter role, an attendee role, a moderator role, a notetaker role, or another type of role. The UI might also be customized for the particular type of client computer that it is displayed upon. For instance, the UI might be customized for the particular screen size, available user input devices, and other features of the client computer upon which it is presented.

The projector role is assigned to a client computer that is connected to an external display device, such as a projector or large monitor. A client computer assigned the projector role is configured to display a presentation on the external display device. The portion of the presentation to be displayed by a client computer that has been assigned the projector role may be defined by a client computer that has been assigned a presenter role. A client computer that has been assigned a presenter role is configured to display a UI that includes the presentation. The UI might also include elements to assist a presenter, such as presenter notes, a timer, and other UI elements.

An attendee role might be assigned to client computers operated by non-presenting meeting participants. Client computers that have been assigned the attendee role might present a UI that displays the presentation along with UI elements to assist a participant. For instance, the UI might include elements for receiving meeting notes that are personal to the participant. The UI might also include elements for receiving questions to be directed to the presenter. The questions may then be synchronized to and displayed by the client computer that has been assigned the presenter role.

A moderator role might be assigned to a client computer operated by a meeting moderator. The UI presented by a client computer that has been assigned the moderator role might display the presentation along with additional UI elements for assigning roles for the other client computers participating in the presentation. The roles assigned by the moderator may then be synchronized to the other client computers. When a client computer receives a new role, it updates its UI to reflect the newly assigned role. Other roles, such as the presenter role, might include UI for assigning roles to other client computers.

A notetaker role might be assigned to a client computer operated by an individual that has been assigned the task of taking shared notes for the meeting. The UI provided by a client computer that has been assigned the notetaker role might display the presentation along with additional UI elements for receiving text notes. The text notes may be synchronized to the other client computers. For instance, the text notes might be synchronized to a client computer that has been assigned the projector role and thereby displayed to the meeting participants.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of the various software components provided herein in embodiments;

FIG. 2 is a data structure diagram showing aspects of an illustrative presentation state data structure utilized in embodiments disclosed herein;

FIG. 3 is a flow diagram showing aspects of the operation of a presentation server application in one embodiment disclosed herein;

FIG. 4 is a flow diagram showing aspects of the operation of a presentation client application in one embodiment disclosed herein; and

FIG. 5 is a computer architecture diagram showing an illustrative computer hardware and software architecture for a computing system capable of implementing the embodiments presented herein.

### DETAILED DESCRIPTION

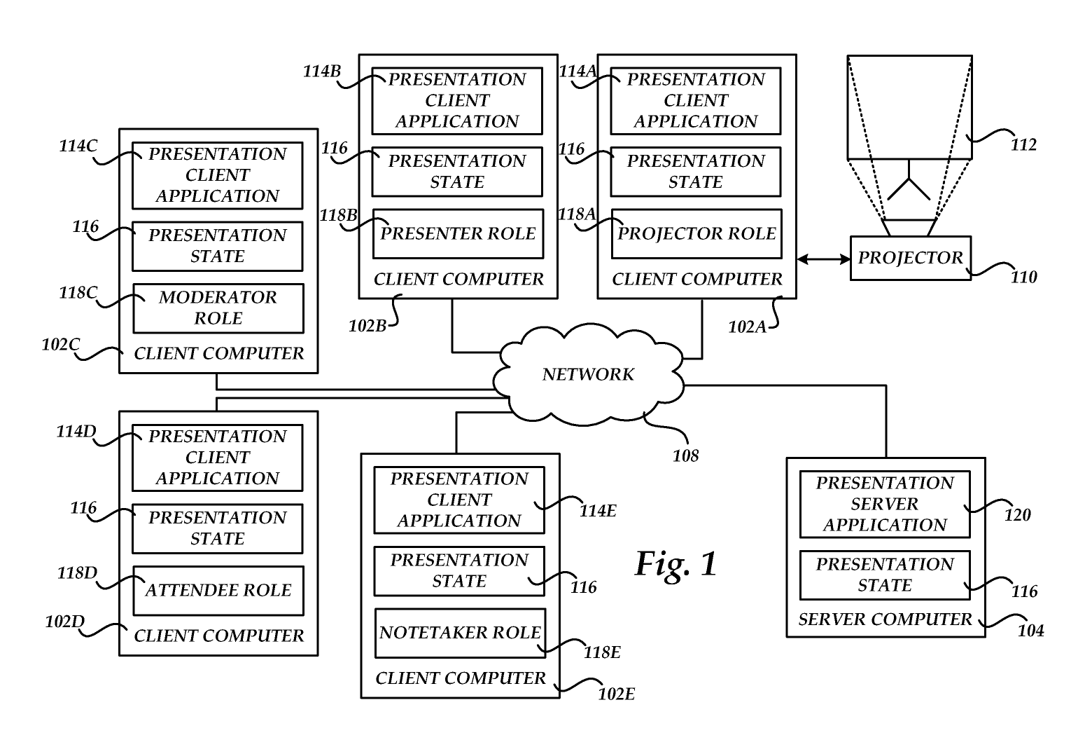

The following detailed description is directed to concepts and technologies for role-based presentation views. According to aspects presented herein, a presentation state that includes a presentation and other information is synchronized between one or more client computers executing a presentation client application. A client computer executing the presentation client application receives the presentation state, including the presentation, and is assigned a role. The client computer then provides a user interface (“UI”) for viewing and interacting with the presentation that is based upon the assigned role. The role might be a projector role, a presenter role, an attendee role, a moderator role, a notetaker role, or another type of role. The UI might also be customized for the particular type of client computer that it is displayed upon. Additional details regarding the presentation state, the operation of the client computers, and the various roles will be provided below with regard to FIGS. 1-5.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system, methodology, and computer-readable storage medium for role-based presentation views will be described.

Turning now to FIG. 1, details will be provided regarding one embodiment presented herein for role-based presentation views. In particular, FIG. 1 is a network diagram showing aspects of the various software components provided herein in embodiments. As shown in FIG. 1, a number of client computers 102A-102E are utilized in embodiments presented herein. The client computers 102A-102E may comprise any type of computer capable of displaying an electronic presentation and a UI for interacting with the presentation. For instance, the client computers 102A-102E may comprise laptop computers, desktop computers, tablet computers, smartphones, personal digital assistants, set top boxes, electronic book readers, and other types of computing devices.

As also shown in FIG. 1, each of the client computers 102A-102E is configured to execute a presentation client application 114. The presentation client application 114 is an executable software component configured to allow a user to view and interact with an electronic presentation. The presentation client application 114 might also provide functionality for editing the presentation and for performing other functions.

According to one implementation, the presentation client application 114 is the POWERPOINT presentation client application from MICROSOFT CORPORATION of Redmond, Wash. It should be appreciated that other presentation client applications from other vendors might also be utilized. It should also be appreciated that while the embodiments described herein are discussed in the context of a presentation client application 114 that performs the functionality described herein, the functionality presented herein might be performed by other software components. For instance, a standalone software component may be provided for performing the various functions described herein. Alternately, a Web page viewable within a Web browser application might perform the functionality described herein for providing role-based presentation views. Other implementations will be apparent to those skilled in the art.

As also shown in FIG. 1, a server computer 104 is utilized in various embodiments presented herein. The server computer 104 comprises a standard server computer and is configured to execute a presentation server application 120. As will be disclosed in greater detail herein, the presentation server application 120 is configured to communicate with the presentation client applications 114A-114E (which may be referred to singularly as the presentation client application 114) executing on the client computers 102A-102E (which may be referred to singularly as a client computer 102), respectively.

The presentation server application 120 is configured to synchronize a presentation state 116 to each of the client computers 102A-102E. As will be disclosed in greater detail below, the presentation state 116 includes a presentation to be displayed by the presentation client applications 114A-114E. The presentation state 116 might also include other data that is synchronized to the client computers 102A-102E and displayed by the presentation client applications 114A-114E depending upon a role assigned to the particular client computer 102A-102E. Additional detail regarding this process will be provided below.

As illustrated in FIG. 1, the client computers 102A-102E and the server computer 104 are interconnected by way of a network 108. It should be appreciated that the network 108 may comprise any suitable computing network for establishing a communications connection between the client computers 102A-102E and the server computer 104. It should also be appreciated that although a single network 108 has been shown in FIG. 1, multiple networks might be utilized. For instance, several of the client computers 102A-102E may be connected by way of a wireless network. Other of the client computers 102A-102E and the server computer 104 might be connected by way of a local area network or a wide area network that is connected to the wireless network. In this regard, it should be appreciated that one or more of the client computers 102A-102E might be located in a common location, such as a meeting room where a presentation is being given, and other of the client computers 102A-102E and the server computer 104 might be remotely located. In this manner, users of the client computers 102A-102E may view and interact with the presentation in the manner described herein whether they are physically located at the site of a presentation or in a remote location.

As described briefly above, each of the client computers 102A-102E may be assigned a role 118. The role 118 assigned to each of the client computers 102A-102E may be determined based upon the type of involvement that a user of each of the client computers 102A-102E will have in the presentation. The role 118 might also be assigned to a particular client computer 102 depending on the role that the client computer 102 will have during the presentation. For instance, in the example shown in FIG. 1, the client computer 102A has been assigned a projector role 118A. The projector role 118A is assigned to client computer 102A that will provide output of the presentation to a projector 110 or other type of external display device. In the example shown in FIG. 1, the client computer 102A is configured with a projector 110 for displaying on a display screen 112. Accordingly, the client computer 102A has been assigned the projector role 118A which causes the presentation client application 114A to retrieve the appropriate portion of the presentation from the presentation state 116 and to cause the presentation to be displayed by the projector 110. It should be appreciated that not every role described herein will necessarily be assigned to the client computers 102 during each meeting. All or a subset of the roles may be assigned to client computers 102.

As will be described in greater detail below, the presentation state 116 is synchronized between the various client computers 102A-102E and the server computer 104. In this way, when a presenter changes the portion of the presentation that should be displayed, for instance by selecting a new slide within the presentation, the presentation state 116 is updated to reflect the current state of the presentation. When an updated presentation state 116 is received, the client computer 102A that has been assigned the projector role 108A updates its output to the projector 110 to reflect the newly selected slide. In this manner, synchronization of the presentation state 116 allows the client computer 102A to continually display the appropriate portion of the presentation.

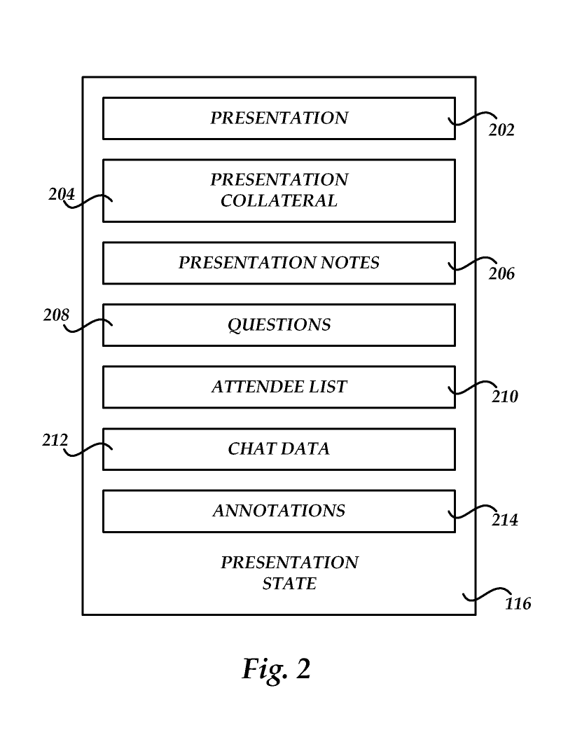

As will also be described in greater detail below, each of the client computers 102B-102E may also utilize the synchronized presentation state 116 to receive updates to the presentation and to add additional information to the presentation state 116 which might be utilized by other of the client computers 102A-102E or the server computer 104. Additional details regarding this process will be provided below with reference to FIGS. 2-5.

In the example shown in FIG. 1, the client computer 102B has been assigned the presenter role 118B. As discussed briefly above, the presenter role 118B is assigned to a client computer 102B operated by a user that is the current presenter in a presentation meeting. When one of the client computers 102A-102E, such as the client computer 102B, is assigned the presenter role 118B, the presentation state 116 may be updated to include a presentation identified by a user of the client computer 102B.

When the presentation state 116 is synchronized to the client computer 102A, which has been assigned the projector role 118A, the presentation identified by the user of the client computer 102B would be displayed by the projector 110. In this manner, the client computer 102A-102E that has been assigned the presenter role 118B will determine the presentation and, more particularly, the portion of the presentation that should be displayed by the client computer 102A that has been assigned the projector role 118A.

According to one embodiment, the presentation client application 114B is configured to generate a UI for viewing and interacting with the presentation that is based upon the role 118A assigned to the client computer 102 upon which the presentation client application 114 is executing. For instance, because the client computer 102B has been assigned the presenter role 118B, the presentation client application 114B may present a UI for interacting with the presentation that is customized for use by a presenter. For instance, in one embodiment, the presentation client application 114B is configured to display a UI for displaying the presentation at the client computer 102B, for displaying presenter notes, and for displaying a timer. Other UI elements might also be displayed by the presentation client application 114B that are suitable for use by a presenter.

In the example shown FIG. 1, the client computer 102C has been assigned a moderator role 118C. The moderator role 118C is assigned to a client computer 102 utilized by an individual that has been assigned the task of moderating a presentation meeting. Accordingly, the presentation client application 114C might present a UI for viewing and interacting with a presentation that is configured for use by a moderator. For instance, in one embodiment, the UI presented by the presentation client application 114C includes a user interface for defining the role 118A-118E that is to be assigned to each of the client computers 102A-102E. In this manner, a moderator might utilize this UI to assign the various roles 118A-118E to the client computers 102A-102E. The user interface provided by a presentation client application 114C on a client computer 102C that has been assigned the moderator role 118C might also include other UI elements suitable for use by a moderator of a meeting.

In the example shown in FIG. 1, the client computer 102D has been assigned an attendee role 118D. The attendee role 118D is assigned to one or more of the client computers 102A-102D, such as the client computer 102D, that are utilized by attendees at a presentation. Accordingly, the presentation client application 114D is configured to display a UI suitable for use by an attendee. In one implementation, the UI presented by the client application 114D on a client computer 102D that has been assigned an attendee role 118D includes a UI for displaying a presentation and for receiving text notes from a user that may or may not be shared with other users.

The UI presented by the presentation client application 114D might also include UI elements for receiving questions from an operator of the client computer 102D. The questions may be synchronized among the client computers 102A-102D through the use of the presentation state 116. Additionally, the questions might be synchronized to a client computer 102B that has been assigned the presenter role 118B and displayed to a user of the client computer 102B. In this way, attendees of a presentation might generate questions for a presenter that are displayed at the client computer 102B utilized by the presenter. It should be appreciated that the UI generated by a presentation client application 114D executing on a client computer 102D that has been assigned an attendee role 118D might include other UI elements not mentioned herein.

In the example shown in FIG. 1, the client computer 102E has been assigned the notetaker role 118E. The notetaker role 118E is assigned to a client computer 102E operated by an individual that has been assigned the task of taking notes during a presentation. Accordingly, the presentation client application 114E executing on a client computer 102E that has been assigned the notetaker role 118E is configured to provide a UI for viewing and interacting with a presentation that is suitable for use by a note taker.

In one embodiment, the presentation client application 114E is configured to display the presentation to a user of the client computer 102E and to provide a user interface for receiving text notes. In order to share the text notes among the client computers 102A-102E, the text notes are added to the presentation state 116, which is then synchronized between the client computers 102A-102E. The text notes might be displayed on the projector 110 by the presentation client application 114A executing on the client computer 102A that has been assigned the projector role 118. It should be appreciated that the presentation client application 114E executing on a client computer 102E that has been assigned a note taker role 118E might also provide other UI elements suitable for use by an individual that has been assigned the task of taking notes during a presentation.

It should also be appreciated that the roles 118A-118E shown in FIG. 1 are merely illustrative and that other roles might be assigned to the various client computers 102A-102E. It should also be appreciated that, according to embodiments, the UI displayed by the presentation client application 114 might also be customized based upon the type of client computer 102A-102E upon which the presentation client application 114 is executing. For instance, the UI might be customized for the particular screen size, available user input devices, and other hardware and software features of the client computer 102 upon which it is executing. In this manner, the UI presented to users of the client computers 102A-102E might be customized based upon the role 118 that has been assigned to the respective client computer 102A-102E, and upon the particular hardware or software characteristics of the respective client computer 102A-102E. It should also be appreciated that, according to embodiments, a client computer 102 or user might be assigned two or more roles. For instance, a client computer 102A might be assigned a presenter role and a projector and/or moderator role.

As mentioned briefly above, the presentation state 116 is synchronized among the client computers 102A-102E in the various embodiments presented herein. In one implementation, the server computer 104 is utilized to synchronize the presentation state between the client computers 102A-102E. It should be appreciated, however, that other types of mechanisms might be utilized to synchronize the presentation state 116 between the client computers 102A-102E. For instance, in one embodiment, the server computer 104 is not utilized. In this embodiment, the client computers 102A-102E are configured as a peer-to-peer network. Using the peer-to-peer network, the client computers 102A-102E can synchronize the presentation state 116 without the use of a dedicated server computer 104. It should be appreciated that other mechanisms might be utilized to synchronize the presentation state 116 between the client computers 102A-102E. Additional details regarding the structure and use of the presentation state 116 and the operation of the presentation client application 114 will be provided below with respect to FIGS. 2-5.

Referring now to FIG. 2, a data structure diagram will be described that shows aspects of an illustrative data structure for implementing the presentation state 116 in one embodiment presented herein. As discussed briefly above, the presentation state 116 includes a presentation 202. The presentation 202 might include one or more slide decks, each of which includes one or more slides. The presentation 202 might also include state data indicating which of the slides should be currently displayed.

According to one embodiment, the presentation state 116 also includes presentation collateral 204. Presentation collateral 204 includes any type of electronic document that might be associated with and utilized in conjunction with a presentation 202. For instance, the presentation collateral 204 might include pictures, audio files, video files, and other types of media. Presentation collateral 204 might also include other types of documents. The presentation collateral 204 might also be stored within the presentation 202.

As described briefly above, the presentation state 116 might be utilized to synchronize various other types of information between the client computers 102A-102E. Accordingly, in various embodiments, the presentation state 116 includes notes 206, questions 208, an attendee list 210, chat data 212, and annotations 214. The notes 206 might be notes taken by a user of the client computer 102E that has been assigned the note taker role 118E. As discussed above, the notes 206 might be synchronized between the client computers 102A-102E and displayed by the client computer 102A that has been assigned the projector role 118A.

As also discussed above, the presentation client application 114D executing on a client computer 102D that has been assigned the attendee role 118D might provide a user interface to allow an attendee to ask a question of the presenter. In the regard, questions 208 may be included in the presentation state 116 and synchronized to the client computer 102B operated by the presenter.

According to implementations, the presentation client application 114E might include functionality for allowing users of the client computers 102A-102E to chat with one another by typing text messages, exchanging audio, and/or audio/video. These messages, which might be referred to herein as chat data 212, may be included in the presentation state 116 and synchronized among the client computers 102A-102E.

In other embodiments, the presentation client application 114D provides functionality for allowing an operator of one of the client computers 102A-102E that has been assigned an appropriate role 118 to annotate the currently displayed presentation. The annotations are textual or graphic information that will be displayed along with the presentation by the client computer 102A that has been assigned the projector role 118. The annotations 214 are included in the presentation state 116 and synchronized among the client computers 102A-102E.

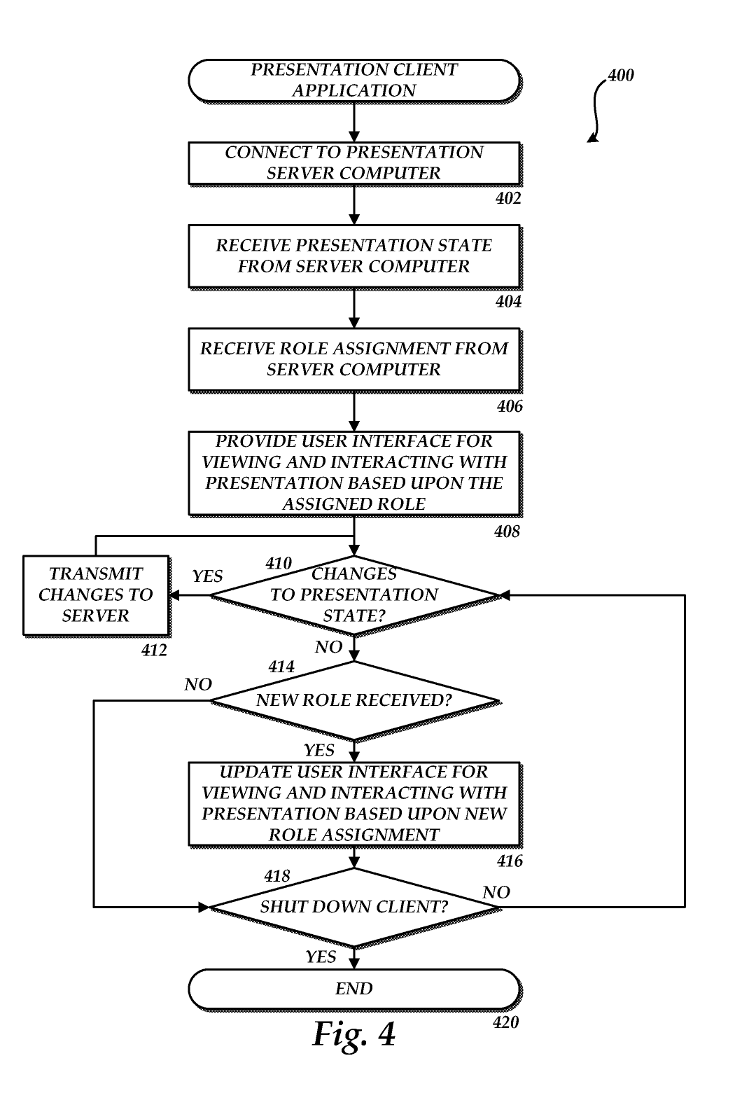

As shown in FIG. 2, the presentation state 116 might also include an attendee list 210. The attendee list 210 might include the names of the operators of each of the client computers 102A-102E. The attendee list 210 might also identify the particular role 118A-118E that each of the client computers 102A-102E has been assigned. When a role is changed for a particular client computer 102A-102E, such as when the presenter changes, the attendee list 210 might be updated to reflect the new role. Additional details regarding modification of a role 118 on a particular client computer 102B will be described below with respect to FIG. 4.

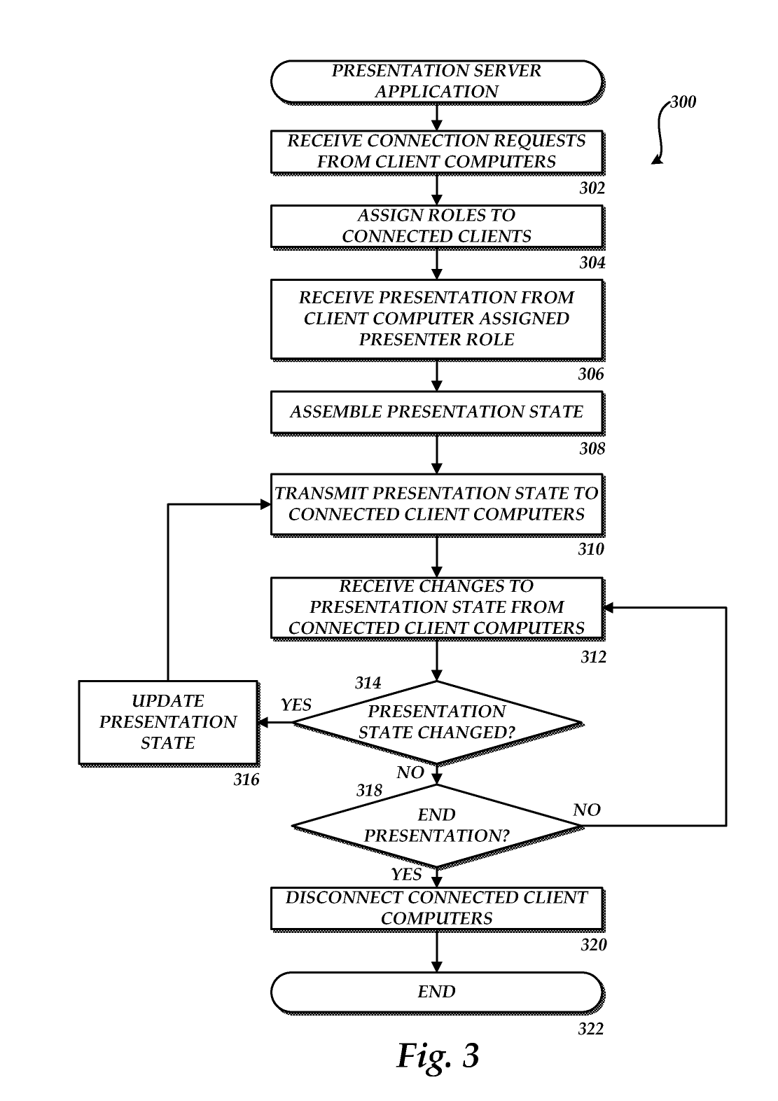

Turning now to FIG. 3, additional details will be provided regarding the embodiments presented herein for role-based presentation views. In particular, FIG. 3 is a flow diagram showing a routine 300 that illustrates aspects of the operation of the presentation server application 120 in one embodiment disclosed herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300 begins at operation 302, where the server computer 104 receives connection requests from the presentation client applications 114A-114E executing on the client computers 102A-102E. The routine 300 then proceeds to operation 304, where the presentation server application 120 assigns roles 118A-118E to the connected client computers 102A-102E. According to embodiments, the roles 118A-118E may be automatically assigned to the client computers 102A-102E as they connect to the server computer 104. As discussed above, a client computer 102C that has been assigned the moderator role 118C might also be used to assign roles 118 to each of the client computers 102A-102E.

From operation 304, the routine 300 proceeds to operation 306, where the server computer 104 receives the presentation 202 from the client computer currently assigned the presenter role 118B. The routine 300 then proceeds to operation 308, where the server computer 104 assembles the presentation state 116. This might include adding the presentation 202, presentation collateral 204, notes 206, questions 208, attendee list 210, chat data 212, and annotations 214 to the presentation state 116.

From operation 308, the routine 300 proceeds to operation 310, where the server computer 104 transmits the presentation state 116 to each of the connected client computers 102A-102E. The routine 300 then proceeds to operation 312, where the server computer 104 receives changes to the presentation state 116 from the connected client computers 312. As discussed above, changes may occur, for instance, when a presenter modifies the currently displayed presentation slide, when attendees add questions, when attendees join or exit the presentation, or for other reasons.

From operation 312, the routine 300 proceeds to operation 314, where the presentation server application 120 determines whether the presentation state 116 has been changed. If the presentation state 116 has been changed, the routine 300 proceeds to operation 316 where the server computer 104 updates that presentation state 116. The routine 300 then proceeds from operation 316 to operation 310 where the updated presentation state 116 is transmitted to the client computers 102A-102E.

If, at operation 314, the presentation server application 120 determines that the presentation state 116 has not been changed, the routine 300 proceeds from operation 314 to operation 318. At operation 318, the server computer 104 determines whether a request has been received to terminate the current presentation. If not, the routine 300 proceeds to operation 312, described above, where additional changes to the presentation state 116 may be received and synchronized to the client computers 102A-102E. If the presentation is to be ended, the routine 300 proceeds from operation 318 to operation 320 where the client computers 102A-102E are disconnected from the server computer 104. Operation of the presentation server application 120 may then terminated. From operation 320, the routine 300 proceeds to operation 322, where it ends.

Referring now to FIG. 4, an illustrative routine 400 will be described that illustrates operation performed by the presentation client application 114 executing on the client computers 102A-102B. In particular, the routine 400 begins at operation 402, where the presentation client application 114 connects to the server computer 104. The routine 400 then proceeds to operation 404 where the presentation client application 114 receives the presentation state 116 from the server computer 104. The presentation client application 104 also receives an assignment of a role 118 from the server computer 104. As discussed above, the role may be specified in an attendee list 210 contained in the presentation state 116. The role 118 may also be specified in another manner.

From operation 406, the routine 400 proceeds to operation 408 where the presentation client application 114 provides a UI for viewing and interacting with the presentation 202 based upon the role 118 assigned to the client computer 102 upon which the presentation client application 114 is executing. As also discussed above, the presentation client application 114 may provide a UI that is customized for the particular hardware or software of the client computer 102 upon which it is executing.

From operation 408, the routine 400 proceeds to operation 410, where the presentation client application 104 determines whether changes have been made to the presentation state 116. For instance, the presentation client application 114 may determine that notes 206, questions 208, chat data 212, or annotations 214 have been added to the presentation state 116 by a user of the client computer 102 upon which it is executing. If so, the routine 400 proceeds to operation 412 where the updated presentation state 116 may be transmitted to the server computer 104. Alternately, only the changed data may be transmitted to the server computer 104 for inclusion in the presentation state 116. If no changes have been made, the routine 400 proceeds to operation 414.

At operation 414, the presentation client application 114 determines whether a new role has been received from the server computer 104. For instance, a presentation state 116 may be received with an updated attendee list 210 that indicates that the role for a particular client computer 102 has been changed. If the role has been changed, the routine 400 proceeds to operation 416, where the presentation client application 114 updates the user interface for viewing and interacting with the presentation 202 based upon the newly assigned role 118. For instance, during a presentation, an individual at the presentation may be an attendee for most of the presentation. During this time, the client computer 102D which they are operating will be assigned an attendee role 118D. At some point during the presentation, the attendee may be asked to become the presenter. When this occurs, the client computer 102D utilized by the attendee will be assigned the presenter role 118B. When the client computer 102B is assigned presenter role 118B, the UI provided by the presentation client application 114D will be modified to reflect the newly assigned role. In this manner, a user of the client computer 102D will be provided a UI suitable for presenting a presentation. It should be appreciated that other role changes may be processed in a similar fashion.

From operation 416, the routine 400 proceeds to operation 418 where a determination is made as to whether a user has requested to shut down the presentation client application 114. If not, the routine 400 proceeds to operation 410, described above, where the processing described above continues. If a request is received to shut down the presentation client application 114, the presentation client application 114 is disconnected from the server computer 104 and its execution is terminated. The routine 400 then proceeds to operation 420, where it ends.

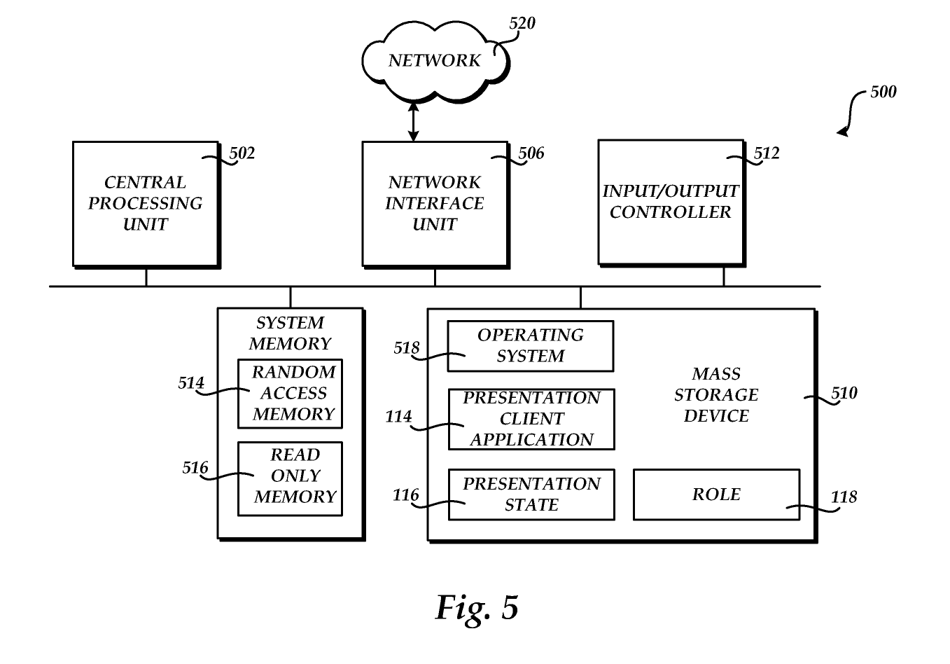

FIG. 5 shows an illustrative computer architecture for a computer 500 capable of executing the software components described herein for role-based presentation views. The computer architecture shown in FIG. 5 illustrates a conventional desktop, laptop computer, or server computer and may be utilized to execute the presentation client application 114 or any of the other software components described herein.

The computer architecture shown in FIG. 5 includes a central processing unit 502 (“CPU”), a system memory 508, including a random access memory 514 (“RAM”) and a read-only memory (“ROM”) 516, and a system bus 504 that couples the memory to the CPU 502. A basic input/output system (“BIOS”) containing the basic routines that help to transfer information between elements within the computer 500, such as during startup, is stored in the ROM 516. The computer 500 further includes a mass storage device 510 for storing an operating system 518, application programs, and other program modules, which will be described in greater detail below.

The mass storage device 510 is connected to the CPU 502 through a mass storage controller (not shown) connected to the bus 504. The mass storage device 510 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable storage media can be any available computer storage media that can be accessed by the computer 500.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 500. As used herein, the term computer-readable storage media does not encompass transitory signals.

According to various embodiments, the computer 500 may operate in a networked environment using logical connections to remote computers through a network such as the network 520. The computer 500 may connect to the network 520 through a network interface unit 506 connected to the bus 504. It should be appreciated that the network interface unit 506 may also be utilized to connect to other types of networks and remote computer systems. The computer 500 may also include an input/output controller 512 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 510 and RAM 514 of the computer 500, including an operating system 518 suitable for controlling the operation of a networked desktop, laptop, or server computer. The mass storage device 510 and RAM 514 may also store one or more program modules. In particular, the mass storage device 510 and the RAM 514 may store the presentation client application 114, the presentation state 116, the role 118, and the other program modules and data described above. The mass storage device 510 and RAM 514 may also store other program modules and data.

In general, software applications or modules may, when loaded into the CPU 502 and executed, transform the CPU 502 and the overall computer 500 from a general-purpose computing system into a special-purpose computing system customized to perform the functionality presented herein. The CPU 502 may be constructed from any number of transistors or other discrete circuit elements, which may individually or collectively assume any number of states. More specifically, the CPU 502 may operate as one or more finite-state machines, in response to executable instructions contained within the software or modules. These computer-executable instructions may transform the CPU 502 by specifying how the CPU 502 transitions between states, thereby physically transforming the transistors or other discrete hardware elements constituting the CPU 502.

Encoding the software or modules onto a mass storage device may also transform the physical structure of the mass storage device or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for role-based presentation views have been presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and storage mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing a role-based view of a presentation, the method comprising performing computer implemented operations for:
receiving a presentation at a client computer;
receiving a role at the client computer; and
providing a user interface (UI) for viewing and interacting with the presentation by way of the client computer, the UI based upon the received role.

2. The computer-implemented method of claim 1, wherein the role comprises a projector role, and wherein the method further comprises causing the presentation to be displayed on a display device external to the client computer.

3. The computer-implemented method of claim 1, wherein the role comprises a presenter role, and wherein the UI comprises a UI for displaying the presentation at the client computer, for displaying presenter notes, and for displaying a timer.

4. The computer-implemented method of claim 1, wherein the role comprises an attendee role, and wherein the UI comprises a UI for displaying the presentation at the client computer and for receiving text notes.

5. The computer-implemented method of claim 1, wherein the role comprises a moderator role, and wherein the UI comprises a UI for defining a role for one more client computers.

6. The computer-implemented method of claim 1, wherein receiving a presentation at a client computer comprises receiving a presentation state containing the presentation.

7. The computer-implemented method of claim 6, wherein the role comprises a notetaker role and the UI comprises a UI for displaying the presentation at the client computer and for receiving text notes, and wherein the method further comprises adding the text notes to the presentation state and causing the presentation state to be synchronized to one or more additional client computers.

8. The computer-implemented method of claim 7, wherein causing the presentation state to be synchronized to one or more additional client computers comprises transmitting the presentation state to a server computer configured to synchronize the presentation state to the one or more additional client computers.

9. The computer-implemented method of claim 7, wherein causing the presentation state to be synchronized to one or more additional client computers comprises synchronizing the presentation state with the one or more additional client computers by way of a peer-to-peer network.

10. The computer-implemented method of claim 6, wherein the presentation state further comprises presentation collateral, notes, questions, and annotations.

11. The computer-implemented method of claim 9, wherein the presentation state further comprises an attendee list and chat data.

12. The computer-implemented method of claim 1, further comprising:
receiving a new role at the client computer; and
providing a new UI for viewing and interacting with the presentation by way of the client computer, the new UI based upon the new role.

13. A computer-readable storage medium having computer-executable instructions stored thereupon which, when executed by a computer, cause the computer to:
receive a presentation at the computer;
receive a role at the computer;
provide a user interface (UI) for viewing and interacting with the presentation by way of the computer, the UI based upon the received role;
receive a new role at the computer; and to
provide a new UI for viewing and interacting with the presentation by way of the computer, the new UI based upon the new role.

14. The computer-readable storage medium of claim 13, wherein the role comprises a projector role, and wherein the computer-readable storage medium has further computer-executable instructions stored thereupon which, when executed by the computer, cause the computer to cause the presentation to be displayed on a display device external to the computer.

15. The computer-readable storage medium of claim 13, wherein the role comprises a presenter role, and wherein the UI comprises a UI for displaying the presentation, presenter notes, and a timer.

16. The computer-readable storage medium of claim 13, wherein the role comprises an attendee role, and wherein the UI comprises a UT for displaying the presentation and for receiving text notes.

17. The computer-readable storage medium of claim 13, wherein the role comprises a moderator role, and wherein the UI comprises a UI for defining a role for one more additional computers.

18. The computer-readable storage medium of claim 13, wherein the role comprises a notetaker role and the UI comprises a UI for displaying the presentation and for receiving text notes that are synchronized to one or more additional computers.

19. A computer-implemented method for providing a role-based view of a presentation, the method comprising performing computer-implemented operations for:
receiving a presentation state at a client computer, the presentation state comprising a presentation;
receiving a role at the client computer, the role comprising one of a projector role, a presenter role, a moderator role, an attendee role, and a notetaker role; and
providing a user interface (UI) for viewing and interacting with the presentation by way of the client computer, the UI based upon the received role.

20. The computer-implemented method of claim 19, further comprising:
receiving a new role at the client computer, the new role comprising one of a projector role, a presenter role, a moderator role, an attendee role, and a notetaker role; and
providing a new UI for viewing and interacting with the presentation by way of the client computer, the new UI based upon the new role.
